(19) United States
(12) Patent Application Publication
(10) Pub. No.: US 2026/0043188 A1
(43) Pub. Date: Feb. 12, 2026

(54) FILTER ASSEMBLY FOR AN APPLIANCE

(71) Applicant: Haier US Appliance Solutions, Inc., Wilmington, DE (US)

(72) Inventor: Roberto Obregon, Louisville, KY (US)

(21) Appl. No.: 18/797,771

(22) Filed: Aug. 8, 2024

(51) Int. Cl. D06F 39/10; B01D 29/01; B01D 29/60; B01D 35/157; B01D 35/30; D06F 34/22; D06F 39/08; D06F 39/12; D06F 103/20; D06F 105/06; D06F 105/08; D06F 105/34; D06F 105/58

(52) U.S. Cl. CPC D06F 39/10; B01D 29/01; B01D 29/601; B01D 35/1573; B01D 35/30; D06F 34/22; D06F 39/085; D06F 39/12; D06F 2103/20; D06F 2105/06; D06F 2105/08; D06F 2105/34; D06F 2105/58

(57) ABSTRACT

An appliance includes a wash tub positioned within a cabinet and defining a wash chamber and an external filter assembly. The external filter assembly includes a filter and an inlet conduit fluidly coupled with the filter and the wash tub. Fluid flows from the wash tub to the filter. The filter assembly includes a recirculation conduit fluidly coupled with the filter and the wash tub. The fluid flows from the filter to the wash tub. The filter assembly further includes a drainage conduit. The fluid flows from at least one of the wash tub or the filter.

### FIELD OF THE INVENTION

The present subject matter relates generally to household appliances. More specifically, to washing machine appliances with filter assemblies.

### BACKGROUND OF THE INVENTION

Washing machine appliances generally include a tub for containing water or wash fluid, e.g., water and detergent, bleach, and/or other wash additives. A basket is rotatably mounted within the tub and defines a wash chamber for receipt of articles for washing. During normal operation of such washing machine appliances, the fluids are directed into the tub and onto articles within the wash chamber of the basket. The basket or an agitation element can rotate at various speeds to agitate articles within the wash chamber, to wring fluids from articles within the wash chamber, etc. During a spin or drain cycle, a drain pump assembly may operate to discharge water from within sump.

Certain conventional washing machine appliances include dispensing assemblies that are configured to dispense water, wash fluid, and/or other additives into the wash chamber at various stages of the operating cycle to facilitate the cleaning of articles located therein. Cleaning these articles can lead to shedding of soils from the articles, microfiber particles, or other forever chemicals. Furthermore, fluids containing these particles may be treated to some degree by municipal treatment plants, some particles can ultimately be discharged into natural water ways and eventually cause ecological harm. Conventional methods for dealing with these particles include using a filter on a discharge outlet, but these methods do not address reusing the fluids before discharging.

Accordingly, a washing machine appliance having improved features for facilitating improved filtering of the fluids discharged from the appliance and the fluids in circulation within the washing machine appliance would be desirable. More specifically, a new system for reusage of fluids would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, an appliance includes a wash tub positioned within a cabinet and defining a wash chamber and an external filter assembly. The external filter assembly includes a filter and an inlet conduit fluidly coupled with the filter and the wash tub. Fluid flows from the wash tub to the filter. The filter assembly includes a recirculation conduit fluidly coupled with the filter and the wash tub. The fluid flows from the filter to the wash tub. The filter assembly further includes a drainage conduit. The fluid flows from at least one of the wash tub or the filter.

In another exemplary embodiment, an external filter assembly is for a washing machine appliance. The external filter assembly includes a filter housing fluidly coupled with the washing machine appliance and a filter disposed within the filter housing and removably coupled thereto. The filter assembly includes an inlet conduit fluidly coupled with a wash tub of the washing machine appliance and the filter and a recirculation conduit fluidly coupled with the filter and the wash tub. The filter assembly includes a drainage conduit fluidly coupled with one chosen from the wash tub and the filter and a diverter valve fluidly coupled with the drainage conduit and one chosen from the recirculation conduit and the inlet conduit. The filter assembly further includes a controller communicatively coupled with the diverter valve. The controller instructs the diverter valve to flow fluids to the drainage conduit or to one chosen from the recirculation conduit and the inlet conduit.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a washing machine appliance according to an example embodiment of the present subject matter.

FIG. 2 provides a rear elevation view of the example washing machine appliance of FIG. 1 according to an example embodiment of the present subject matter.

FIG. 3 provides a rear perspective view of an example washing machine appliance having a drainage conduit coupled thereto according to an example embodiment of the present subject matter.

FIG. 4 provides a schematic view of a fluid circulation assembly of the example washing machine appliance of FIG. 1 according to an example embodiment of the present subject matter.

FIG. 5 provides another schematic view of the example fluid circulation assembly of FIG. 3 illustrating a recirculation conduit according to an example embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In order to aid understanding of this disclosure, several terms are defined below. The defined terms are understood to have meanings commonly recognized by persons of ordinary skill in the arts relevant to the present invention. The terms “includes” and “including” are intended to be inclusive in a manner similar to the term “comprising. ” Similarly, the term “or” is generally intended to be inclusive (i.e., “A or B” is intended to mean “A or B or both”). The terms “first,” “second,” and “third” may be used interchangeably to distinguish one element from another and are not intended to signify location or importance of the individual elements. Terms such as “inner” and “outer” refer to relative directions with respect to the interior and exterior of the washing machine appliance, and in particular the wash basket therein. For example, “inner” or “inward” refers to the direction towards the interior of the washing machine appliance. Terms such as “left,” “right,” “front,” “back,” “top,” or “bottom” are used with reference to the perspective of a user accessing the washing machine appliance. For example, a user stands in front of the washing machine appliance to open the door and reaches into the wash basket to access items therein. Furthermore, it should be appreciated that as used herein, terms of approximation, such as “approximately,” “substantially,” or “about,” refer to being within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counterclockwise.

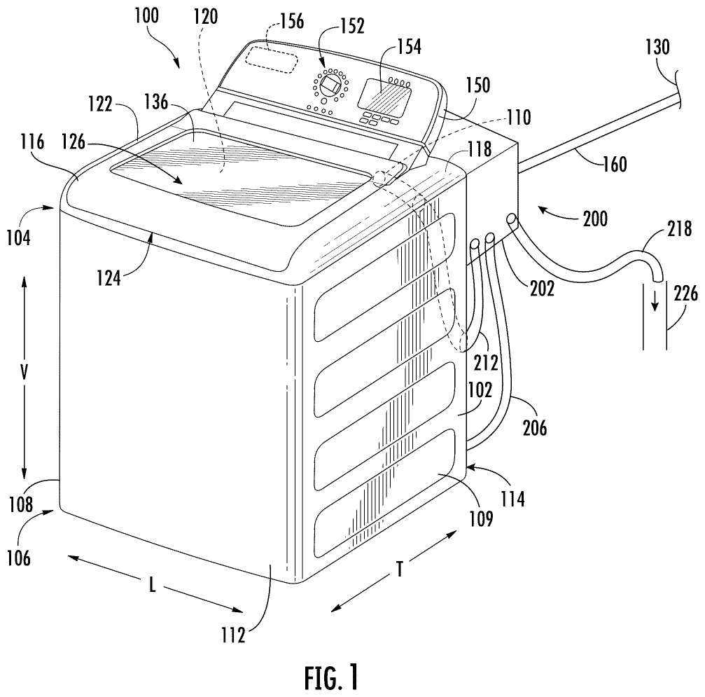

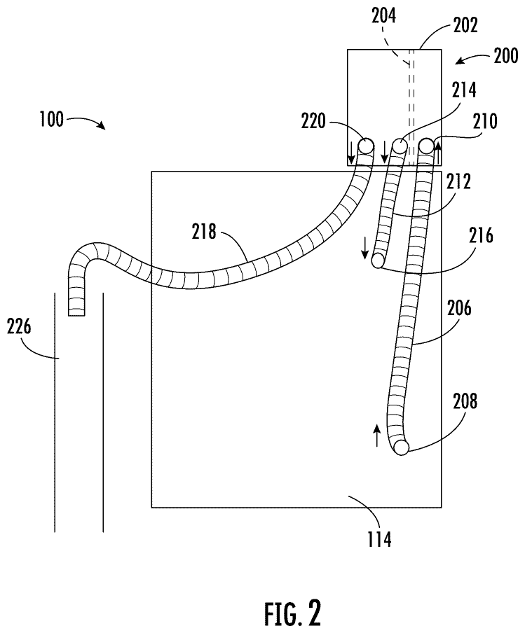

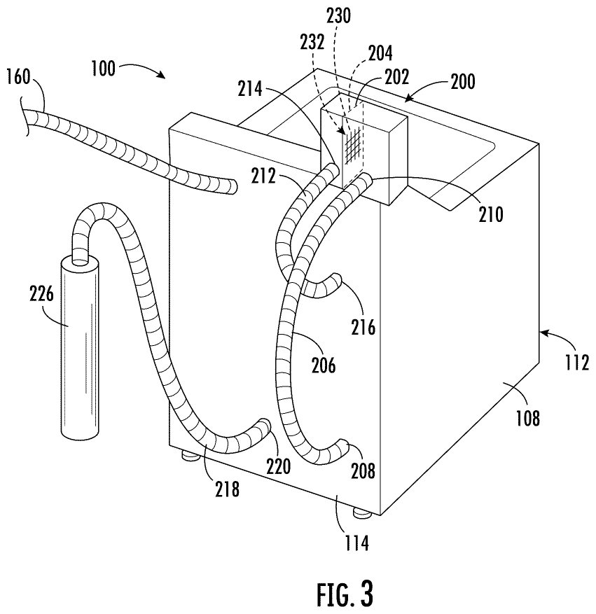

Referring now to the figures, FIG. 1 is a perspective view of an exemplary washing machine appliance 100, FIG. 2 is a rear elevation view of the washing machine appliance 100, and FIG. 3 is a rear perspective view of the washing machine appliance 100 having a drainage conduit coupled thereto. As illustrated, washing machine appliance 100 generally defines a vertical direction V, a lateral direction L, and a transverse direction T, each of which is mutually perpendicular, such that an orthogonal coordinate system is generally defined. Washing machine appliance 100 includes a cabinet 102 that extends between a top 104 and a bottom 106 along the vertical direction V, between a left side 108 and a right side 109 along the lateral direction, and between a front 112 and a rear 114 along the transverse direction T.

Referring generally to FIGS. 1 through 3, the washing machine appliance 100 defines a wash tub 124 and defines a wash chamber 126 that is configured for receipt of articles for washing. The wash chamber 126 may contain a wash basket 120 that is rotatably mounted within cabinet 102 such that it is rotatable. A motor may be in mechanical communication with wash basket to selectively rotate wash basket 120 (e.g., during an agitation or a rinse cycle of washing machine appliance 100). The wash basket 120 is received within the wash tub 124 and defines the wash chamber 126 that is configured for receipt of articles for washing. The wash tub 124 holds wash and rinse fluids for agitation in wash basket 120 within wash tub 124. As used herein, “fluid” or “fluids” may refer to water, detergent, fabric softener, bleach, or any other suitable wash additive or combination thereof. Indeed, for simplicity of discussion, these terms may all be used interchangeably herein without limiting the present subject matter to any particular “fluid.”

Wash basket 120 may define one or more agitator features that extend into wash chamber 126 to assist in agitation and cleaning articles disposed within wash chamber 126 during operation of washing machine appliance 100. The washing machine appliance illustrated is a top loader. More specifically, wash basket 120 is rotatably mounted within wash tub 124 such that it is rotatable about an axis of rotation AR. According to the illustrated embodiment, the axis of rotation is substantially parallel to the vertical direction V. In this regard, washing machine appliance 100 is generally referred to as a “vertical axis” or “top load” washing machine appliance 100. However, it should be appreciated that aspects of the present subject matter may be used within the context of a horizontal axis or front load washing machine appliance as well.

Referring generally to FIGS. 1 through 3, cabinet 102 also includes a top panel 118 which defines a chamber opening 116 that permits user access to wash basket 120 of wash tub 124. More specifically, washing machine appliance 100 includes a door 122 that is positioned over chamber opening 116 and is rotatably mounted to top panel 118. In this manner, door 122 permits selective access to chamber opening 116 by being movable between an open position facilitating access to a wash tub 124 and a closed position (FIG. 1) prohibiting access to wash tub 124.

A window 136 in door 122 permits viewing of wash basket 120 when door 122 is in the closed position, e.g., during operation of washing machine appliance 100. Door 122 may also include a handle (not labeled) that, e.g., a user may pull when opening and closing door 122. Further, although door 122 is illustrated as mounted to front panel 130, it should be appreciated that door 122 may be mounted to another side of cabinet 102 or any other suitable support according to alternative embodiments.

A sump 142 is defined by wash tub 124 at a bottom of wash tub 124 along the vertical direction V. Thus, sump 142 is configured for receipt of and generally collects fluids during operation of the washing machine appliance 100. For example, during operation of washing machine appliance 100, fluids may be urged by gravity from basket 120 to sump 142.

A drain pump assembly 144 is located beneath wash tub 124 and is in fluid communication with sump 142 for periodically discharging soiled fluids from washing machine appliance 100. Drain pump assembly 144 may generally include a drain pump 146 which is in fluid communication with sump 142 and with an external drain 148 through a drain hose 150. During a drain cycle, drain pump 146 urges a flow of fluids from sump 142, through drain hose 150, and to external drain 148. More specifically, drain pump 146 includes a motor (not shown) which is energized during a drain cycle such that drain pump 146 draws fluids from sump 142 and urges it through drain hose 150 to external drain 148.

A water supply conduit 160 is configured for directing a flow of fluid into wash tub 124. For example, water supply conduit 160 may be in fluid communication with a water supply 154 in order to direct fluid (e.g., clean water or wash fluid) into wash tub 124 through a primary dispenser 110.

In addition, a water supply valve 158 may allow fluids from the water supply source 130 (such as a municipal water supply) into a detergent dispenser, for example, and into the wash tub 124. In this manner, water supply valve 158 may generally be operable to supply water into detergent dispenser to generate a wash fluid, e.g., for use in a wash cycle, or a flow of fresh water, e.g., for a rinse cycle. It should be appreciated that water supply valve 158 may be positioned at any other suitable location within cabinet 102. In addition, although water supply valve 158 is described herein as regulating the flow of “fluids,” it should be appreciated that this term includes, water, detergent, other additives, or some mixture thereof.

A control panel 150 including a plurality of input selectors 152 is coupled to the cabinet 102. Control panel 150 and input selectors 152 collectively form a user interface input for operator selection of machine cycles and features. For example, in one embodiment, a indicia 154, or a display, indicates selected features, a countdown timer, and/or other items of interest to machine users.

Operation of washing machine appliance 100 is controlled by a controller 156 or processing device that is operatively coupled to control panel 150 for user manipulation to select washing machine cycles and features. In response to user manipulation of control panel 150, controller 156 operates the various components of washing machine appliance 100 to execute selected machine cycles and features.

Controller 156 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 156 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Control panel 150 and other components of washing machine appliance 100 may be in communication with controller 156 via one or more signal lines or shared communication buses.

During operation of washing machine appliance 100, laundry items are loaded into wash basket 120 through chamber opening 116, and washing operation is initiated through operator manipulation of input selectors 152. Wash tub 124 is filled with water, detergent, and/or other fluid additives, e.g., via water supply conduit 160 and or detergent drawer (not shown). One or more valves (e.g., water supply valve 158) can be controlled by washing machine appliance 100 to provide for filling wash basket 120 to the appropriate level for the amount of articles being washed and/or rinsed. By way of example for a wash mode, once wash basket 120 is properly filled with fluid, the contents of wash basket 120 can be agitated (e.g., with ribs 128) for washing of laundry items in wash basket 120.

After the agitation phase of the wash cycle is completed, wash tub 124 can be drained. Laundry articles can then be rinsed by again adding fluid to wash tub 124, depending on the particulars of the cleaning cycle selected by a user. One or more spin cycles may also be used. In particular, a spin cycle may be applied after the wash cycle and/or after the rinse cycle in order to wring fluids from the articles being washed. After articles disposed in wash basket 120 are cleaned, washed, and/or rinsed, the user can remove the articles from wash basket 120, e.g., by opening door 122 and reaching into wash basket 120 through chamber opening 116.

Notably, the washing machine appliance 100 may tend to release microfibers, due to mechanical action exerted on the clothes being washed. These microfibers may ultimately result in tainted ground water, thereby resulting in damage to local ecosystems resulting in poor ecological health. Accordingly, it may be desirable to incorporate a filter assembly 200 with the washing machine appliance 100 to facilitate the removal of these microfibers. Conventional methods for filtering the fluids may include internal filters that merely clean drained fluids. However, the use of a filter in this manner does not address the fluids that could be recirculated for improved efficiency of the washing machine appliance 100. Accordingly, aspects of the present subject matter may be directed to improved systems and methods for a filtering assembly 200 for the washing machine appliance 100.

With reference to FIGS. 1 through 5, the filter assembly 200 includes a filter housing 202 coupled with an exterior surface of the cabinet 102. For example, the filter housing 202 may be coupled with the rear side 114 of the cabinet 102. Additionally, or alternatively, the filter housing 202 may be coupled with either the right side 109 or the left side 108 of the cabinet 102. The filter assembly 200 further includes a filter 204 (FIGS. 2 through 5) disposed within the filter housing 202. The filter 204 may be removably coupled with the filter housing 202, such that the filter 204 can be periodically removed for cleaning. For example, the filter 204 may be coupled with the filter housing 202 via a friction fit, fasteners, tongue-in-groove connections, or another similar suitable coupling mechanism.

The filter 204 includes a mesh 230 (FIG. 3) configured to trap particles and other soils suspended in the fluids. The mesh 230 defines a plurality of mesh holes 232. The mesh holes 232 may have an opening of about 40 micrometers to 110 micrometers, or μm. The term opening in this context refers to a distance between a wire, or strand, or the mesh 230. Additionally, or alternatively, the mesh holes 232 may have an opening of about 50 μm to about 100 μm. Additionally, or alternatively, the mesh holes 232 may have an opening of about less than about 50 μm. The mesh 230 is configured to catch fibers, and more specifically, microfibers, while allowing fluids to pass through the mesh holes 232. For example, a human hair may have an opening of about 70 μm and a length of 1 mm (millimeter); therefore, the mesh 230 is likely to catch the example human hair.

The mesh 230 may be made from a polymeric material. Additionally, or alternatively, the mesh 230 may be made from a metallic material. For example, polypropylene has a suitable modulus of elasticity, density, and chemical resistance that make polypropylene an overall suitable material for use in the mesh 230 of the filter 204 for filtering fluids of the washing machine appliance 100. Additionally, or alternatively, polyester has comparable qualities and may also make up the mesh 230. Additionally, or alternatively, polyamides may be a suitable material for the mesh 230 for similar reasons, including abrasion resistance. Furthermore, the filter 204 is described as comprising the mesh 230; however, the filter 204 may comprise a series of meshes in order to maximize filtering of the fluids. Even further, the filtering assembly 200 is described herein as comprising the filter 204; however, the filtering assembly may comprise a plurality of filters that are stacked in series or in sequence, for example.

The filter assembly 200 further comprises an inlet conduit 206 fluidly coupled between the filter housing 202 and the wash tub 124. More specifically, the wash tub 124 defines a first inlet port 208 coupled with the inlet conduit 206, and the filter house defines a second inlet port 210 coupled with the inlet conduit 206. The inlet conduit 206 may be generally cylindrical, as illustrated for example. The inlet conduit 206 is configured to direct fluids from the wash tub 124 to the filter housing 202.

The filter assembly 200 further comprises a recirculation conduit 212 fluidly coupled between the filter housing 202 and the wash tub 124. More specifically, the filter housing 202 defines a first recirculation port 214 coupled with the recirculation conduit 212, and the wash tub 124 defines a second recirculation port 216 coupled with the recirculation conduit 212. Similarly to the inlet conduit 206, the recirculation conduit 212 may also be generally cylindrical, as illustrated for example. The recirculation conduit 212 is configured to direct fluids from the filter housing 202 to the wash tub 124.

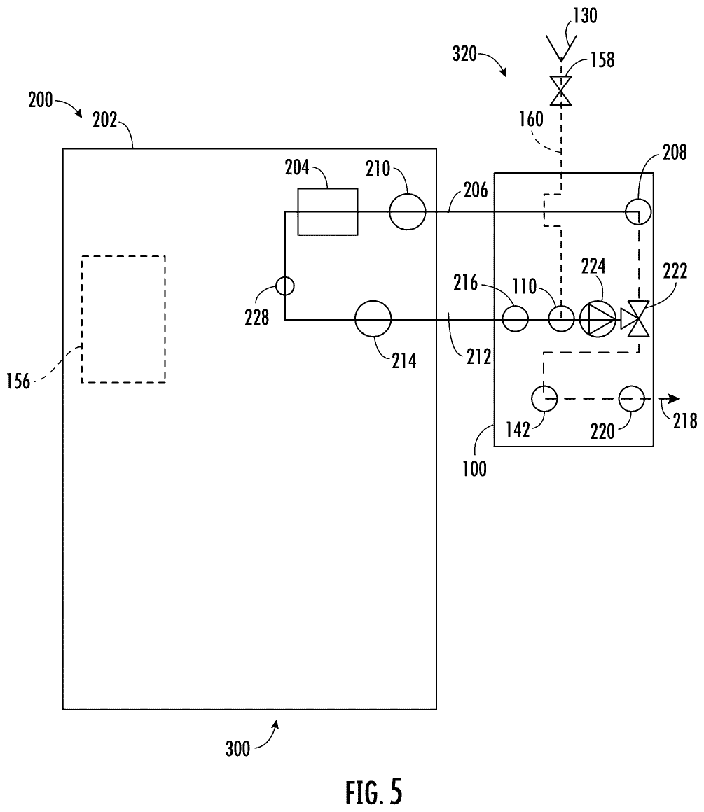

The filter assembly further comprises a drainage conduit 218 coupled with a drainage port 220. The drainage port 220 may be defined by the wash tub 124. Additionally, or alternatively, the drainage port 220 may be defined by the filter housing 202. The drainage conduit 218 may be fluidly coupled with the filter housing 202, as illustrated in the example of FIGS. 1, 2 and 4. Additionally, or alternatively, the drainage conduit 218 may be fluidly coupled with the wash tub 124, as illustrated in the example of FIGS. 3 and 5. The drainage conduit 202 may also be fluidly coupled with an external drain 226. The external drain 226 may ultimately lead to natural water ways.

Even further, the filter assembly comprises a pump 224 that may be disposed within the cabinet 102. The pump 224 may be fluidly coupled with the drainage conduit 218 to push fluids out of the wash tub 124. Additionally, or alternatively, the pump 224 may be disposed within the filter housing 202. The pump 224 may be fluidly coupled with the inlet conduit 206 to pull fluids into the filter housing 202. Additionally, or alternatively, the pump 224 may be integrated into the flow path of the fluids at any location along a flow path 300 to promote the flow of the fluids. Additionally, or alternatively, the pump 224 may be integrated into the flow path 300 of the fluids at any location along the flow path 300 that is not already assisted by gravity.

The pump 224 may be any suitable type and configuration of fluid pump for urging flow of the fluids. For example, according to an example embodiment, the pump 224 may be a bidirectional direct current (DC) pump. According to such an embodiment, the pump 224 may be fluidly coupled to both the inlet conduit 206 and the drainage conduit 218 for selectively urging flow of the fluids through one of or both the drainage conduit 218 and the inlet conduit 206. For example, the pump 224 may operate in one direction to discharge the fluids through the drainage conduit 218 to external drain 226 and may operate in the other direction to circulate or recirculate the fluids through the inlet conduit 212.

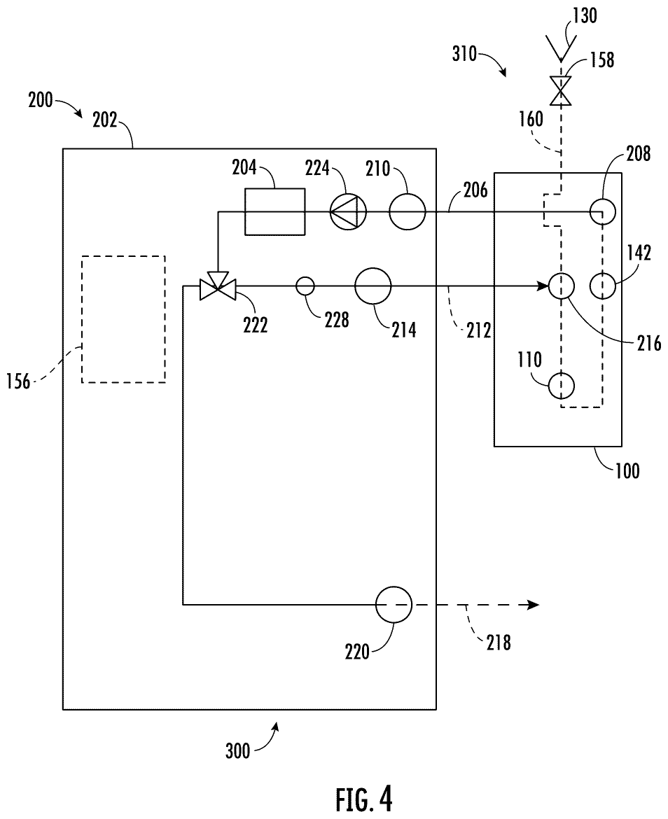

With reference now generally to FIGS. 4 and 5, the filter assembly 200 includes a diverter valve 222 communicatively coupled with the controller 156. The diverter valve 222 is fluidly coupled with the drainage conduit 218 and at least one of the inlet conduit 206 and the recirculation conduit 212. As illustrated in FIG. 4, the diverter valve 222 may be fluidly coupled with the inlet conduit 206, the recirculation conduit 212, and the drainage conduit 218. Additionally, or alternatively, the diverter valve 222, as illustrated in FIG. 5, may be fluidly coupled with the drainage conduit 218 and the recirculation conduit 212. The diverter valve 222 is configured to divert the flow of the fluids along the flow path 300 between the fluids recirculating through the flow path 300 and the fluids draining out the drainage conduit 218.

With further reference to FIGS. 4 and 5, the filter assembly includes a particle sensor 228 communicatively coupled with the controller 156. The particle sensor 228 may comprise, for example, at least one of a turbidity sensor, a laser particle counter, a nephelometer, a flow cytometer, an acoustic sensor, a capacitive or resistive sensor, or a micro-electro-mechanical sensor. The particle sensor 228 is configured to sense a quantity of particles entering the recirculation conduit 212. Additionally, or alternatively, the particle sensor 228 may be configured to sense particles between the filter 204 and the recirculation conduit 212. Although a flow path 300 will be described below according to example embodiments, it should be appreciated that variations and modifications may be made while remaining within the scope of the present subject matter.

In one example, the flow path 300 includes the fluids starting at the water supply source 130; flowing through the water supply valve 158; flowing through the primary dispenser 110 into the wash tub 124 of the washing machine appliance 100; flowing through the sump 142; flowing up through the inlet conduit via the pump 224; flowing though the filter 204; flowing through the diverter valve 222 directed, or routed, to the recirculation conduit 212; flowing past the particle sensor; flowing through the recirculation conduit 212 back to the primary dispenser 110 to define a first sub cycle 310 starting with the primary dispenser 110; repeating the first sub cycle 310 for a first duration of time in response to the particle sensor sensing a quantity of particles that is above a predetermined range; flowing through the diverter valve toward the drainage conduit in response to the particle sensor 228 sensing a quantity of particles that is below the predetermined range. The recirculation time is defined as a minimum time that one particle of fluid takes to go through the loop defined by the primary dispenser 110, tub 104, sump 142, pump 224, filter 204, diverter valve 222, particle sensor 228, and back to the primary dispenser 110. The recirculation time is directly proportional to the amount of fluid within the first sub cycle 310 of the flow path 300 and inversely proportional to the flow rate. Additionally, or alternatively, a pump curve Pressure vs. Flow rate may be used to derive the predetermined recirculation time. For example, the first sub cycle 310 may continue for sixty seconds which may be equal to the total amount of fluid recirculating one time in the first sub cycle 310.

The predetermined range of particles released from the drainage conduit 218 may be determined by local water municipalities. The predetermined range of particles may be read by the controller 156 and compared to the quantity of particles sensed by the particle sensor 228. For example only, the predetermined range of particles may be about 1 to 2 parts per million (PPM).

In another example, the flow path 300 includes the fluids starting at the water supply source 130; flowing through the water supply valve 158; flowing through the primary dispenser 110 into the wash tub 124 of the washing machine appliance 100; flowing through the diverter valve 222 directed, or routed, to the inlet conduit 206; flowing up through the inlet conduit 206 via the pump 220; flowing through the filter 204; flowing past the particle sensor 228; flowing through the recirculation conduit 212; flowing back through the primary dispenser to define a second sub cycle 320 starting with the primary dispenser 110; repeating the second sub cycle 320 for a second recirculation time in response to the particle sensor sensing the quantity of particles that is above a predetermined range; flowing through the diverter valve toward the sump 142 in response to the particle sensor 228 sensing a quantity of particles that is below the predetermined range; flowing up though the drainage conduit 218 via the pump 224 out to the external drain 226. The recirculation time may be proportional to the amount of fluid within the second sub cycle 320 of the flow path 300 circulating a number of times. For example, the second sub cycle 320 may continue for sixty seconds which may equal to the total amount of fluid recirculating one time in the second sub cycle 310.

As illustrated in FIGS. 4 and 5, the flow path 300 includes the fluid flowing through first inlet port 228, the second inlet port 210, the first recirculation port 214, the second inlet port 216, as well as the drainage port 220. Additionally, or alternatively, the first sub cycle 310 and the second sub cycle 320 may occur over a predetermined duration of time based on programming from a manufacturer. The predetermined time is proportional to the amount of fluid within the flow path 300 circulating a number of times. For example, the first sub cycle 310 may occur five times before fluid is discharged through the drainage conduit 218.

It should be appreciated that various features of filter assembly 200 may be formed from any suitably rigid material. For example, according to exemplary embodiments, the filter housing 202 may be formed by injection molding, e.g., using a suitable plastic material, such as injection molding grade Polybutylene Terephthalate (PBT), polyamides, high impact polystyrene (HIPS), acrylonitrile butadiene styrene (ABS), or any other suitable blend of polymers. Alternatively, according to the exemplary embodiment, these components may be compression molded, e.g., using sheet molding compound (SMC) thermoset plastic or other thermoplastics. According to still other embodiments, portions of the filter housing 202 may be formed from any other suitable rigid material. In addition, it should be appreciated that one or more features of filter housing 202 may be integrally molded as a single component.

The present subject matter provides several advantages over existing washing machine designs. For example, the system described herein allows for the recirculation of filtered fluids. The system utilizes water that is already in the washing machine appliance and does not require additional water to be added to the cycle, thus minimizing impact on efficiency. In addition, the system described herein utilizes one pump for simplicity and elegance. Furthermore, the system described herein utilizes an external filter assembly that can easily be cleaned, maintained, and swapped without unnecessary disassembly of the washing machine appliance.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An appliance comprising:
a wash tub positioned within a cabinet and defining a wash chamber;
an external filter assembly comprising:
a filter;
an inlet conduit fluidly coupled with the filter and the wash tub,
wherein fluid flows from the wash tub to the filter; and
a recirculation conduit fluidly coupled with the filter and the wash tub, wherein the fluid flows from the filter to the wash tub; and
a drainage conduit, wherein the fluid flows from at least one of the wash tub or the filter.

2. The appliance of claim 1, wherein the appliance further comprises:
a pump fluidly coupled with the recirculation conduit and the drainage conduit; and
a diverter valve coupled with the drainage conduit and at least one of the recirculation conduit or the inlet conduit.

3. The appliance of claim 2, wherein the external filter assembly further comprises a filter housing, wherein the filter is disposed within the filter housing.

4. The appliance of claim 2, wherein the filter housing is coupled with an exterior surface of the appliance.

5. The appliance of claim 2, wherein the diverter valve is disposed within the filter housing, and wherein the diverter valve routes fluid to one chosen from the recirculation conduit and the drainage conduit.

6. The appliance of claim 2, wherein the appliance further comprises:
a controller in communication with the diverter valve; and
a particle sensor configured to sense particles entering the recirculation conduit, wherein the fluid flows from the wash tub to the inlet conduit to the filter to the recirculation conduit to the wash tub for a predetermined duration based on a quantity of particles entering the recirculation conduit before the controller instructs the diverter valve to direct the fluid from the filter to the drainage conduit.

7. The appliance of claim 1, wherein the filter comprises a mesh configured to trap particles including clothe fibers.

8. The appliance of claim 7, wherein the mesh is made from at least one of polypropylene, polyester, polyamides, or a metallic material.

9. The appliance of claim 8, wherein the mesh defines holes that are about 50 μm to about 100 μm in opening.

10. The appliance of claim 1, wherein the external filter assembly allows for the filter to be removed for periodic cleaning.

11. The appliance of claim 1, wherein the fluid flows from the wash tub to the inlet conduit to the filter to the recirculation conduit to the wash tub a predetermined duration of time before flowing from the filter to the drainage conduit.

12. An external filter assembly for a washing machine appliance, the external filter assembly comprising:
a filter housing fluidly coupled with the washing machine appliance;
a filter disposed within the filter housing and removably coupled thereto;
an inlet conduit fluidly coupled with a wash tub of the washing machine appliance and the filter;
a recirculation conduit fluidly coupled with the filter and the wash tub;
a drainage conduit fluidly coupled with one chosen from the wash tub and the filter;
a diverter valve fluidly coupled with the drainage conduit and one chosen from the recirculation conduit and the inlet conduit; and
a controller communicatively coupled with the diverter valve, wherein the controller instructs the diverter valve to flow fluids to the drainage conduit or to one chosen from the recirculation conduit and the inlet conduit.

13. The external filter assembly of claim 12 further comprising:
a particle sensor communicatively coupled with the controller, the particle sensor configured to sense particles entering the recirculation conduit, wherein the particle sensor signals the controller in response to sensing a quantity of particles.

14. The external filter assembly of claim 13 further comprising an indicia communicatively coupled with the controller, wherein the indicia indicates a state of the filter based on the controller determining the quantity of particles sensed by the particle sensor is above a predetermined range.

15. The external filter assembly of claim 13, wherein the controller instructs the diverter valve to route the fluids from the filter to the drainage conduit based on the controller determining the quantity of particles sensed by the particle sensor is below a predetermined range.

16. The external filter assembly of claim 12, wherein fluids flow from the wash tub to the inlet conduit, wherein the fluid flows from the filter to the recirculation conduit, wherein the fluid flows from the wash tub to the inlet conduit, and wherein the fluid flows from the filter to the drainage conduit.

17. The external filter assembly of claim 12, wherein the filter comprises a mesh made from at least one of polypropylene, polyester, polyamides, or a metallic material.

18. The external filter assembly of claim 17, wherein the mesh defines mesh holes that are less than about 50 μm in opening.

19. The external filter assembly of claim 12 further comprising a pump fluidly coupled with the drainage conduit.

20. The external filter assembly of claim 19, wherein the pump is disposed within the filter housing.
